(19) United States
(12) Patent Application Publication
(10) Pub. No.: US 2013/0226684 A1
(43) Pub. Date: Aug. 29, 2013

(54) MERCHANT CONFIGURATION THROUGH PAYMENT NETWORK

(71) Applicants: Ayman Hammad, Pleasanton, CA (US); Prakash Hariramani, San Francisco, CA (US)

(72) Inventors: Ayman Hammad, Pleasanton, CA (US); Prakash Hariramani, San Francisco, CA (US)

(21) Appl. No.: 13/598,474

(22) Filed: Aug. 29, 2012

Related U.S. Application Data
(60) Provisional application No. 61/528,498, filed on Aug. 29, 2011.

(51) Int. Cl. G06Q 30/02

(52) U.S. Cl. CPC G06Q 30/0222
USPC 705/14.23

(57) ABSTRACT

Embodiments of the invention are related to systems and methods for applying a discount to an electronic transaction based on control data stored in a portable merchant device. An access device interacts with a portable merchant device associated with a merchant, the portable merchant device storing control data. A processor in the access device generates a message including the control data, and electronically transmits the message to a server computer. The control data causes the server computer to reconfigure for a transaction conducted by the merchant.

### CROSS-REFERENCES TO RELATED APPLICATIONS

This application claims the benefit of U.S. Provisional Application No. 61/528,498 filed Aug. 29, 2011, entitled “MERCHANT CONFIGURATION THROUGH PAYMENT NETWORK,” which is herein incorporated by reference in its entirety for all purposes.

### BACKGROUND

Embodiments of the invention are directed to systems, apparatuses, and methods for applying a discount to an electronic transaction based on control data stored in a portable merchant device.

Merchants that sell goods or services often provide various promotions to increase sales revenue, attract new customers, and reward loyal existing customers. For example, merchants may offer price reductions, coupons, free products or services, and other promotions that can be redeemed during a predetermined period of time. Such promotions must generally be advertised in advance of the redemption period, and must typically be redeemable by customers until the end of the redemption period.

Once a promotion has been advertised by a merchant to the public, the merchant typically retains little if any control over customers' redemption of the promotion. Thus, merchants may desire an efficient and convenient way to adjust the redemption period for a promotion based upon customer demand to maximize the merchant's sales revenue. For example, merchants may want to encourage customers to redeem a promotion at times when business is slow, and discourage redemption at times during which the merchant is already experiencing a high transaction volume. Thus, a need exists for the dynamic discounts that can be adjusted by a merchant instantaneously.

Embodiments of the invention address the above problems, and other problems, individually and collectively.

### SUMMARY

Embodiments of the invention are directed to systems, apparatuses, and methods for applying a discount to an electronic transaction based on control data stored in a portable merchant device.

One embodiment of the invention is directed to a method performed by an access device, the method comprising interacting with a portable merchant device associated with a merchant, the portable merchant device storing control data. A processor in the access device generates a message including the control data, and the message is electronically transmitted to a server computer. The control data causes the server computer to reconfigure for a transaction conducted by the merchant.

Another embodiment of the invention is directed to a method performed by a server computer, the method comprising receiving a message including control data, the message being generated by an access device that interacts with a portable merchant device associated with the merchant, the portable merchant device storing the control data. The server computer reconfigures for a transaction conducted by the merchant.

Another embodiment of the invention is directed to a computing device comprising a processor and a computer readable medium coupled to the processor, the computer readable medium comprising code executable by the processor for implementing a method. The method comprises interacting with a portable merchant device associated with a merchant, the portable merchant device storing control data. A message is generated including the control data, the message being electronically transmitted to a server computer. The control data causes the server computer reconfigure for a transaction conducted by the merchant.

In embodiments of the invention, the control data can be associated with a discount, and the reconfiguration of the server computer can relate to applying the discount to the transaction conducted by the merchant. Although discounts are described in detail herein, embodiments of the invention are directed to other types of control data. For example, the control data can be associated with a selection by the merchant of a particular payment processing network for processing the transaction, a particular interchange or switch fee structure associated with processing the transaction processing, a deferred settlement of the transaction (e.g., where the merchant agrees to defer settlement of the transaction in exchange for a reduced interchange or switch fee), or other specific services.

These and other embodiments of the invention are described in further detail below with reference to the Figures and the Detailed Description.

### BRIEF DESCRIPTION OF THE DRAWINGS

FIG. 1 shows a block diagram of a payment processing system according to an embodiment of the invention.

FIGS. 2A-2B show block diagrams of exemplary portable merchant devices according to an embodiment of the invention.

FIG. 3 shows a block diagram of a payment processing network according to an embodiment of the invention

FIG. 4 shows a discount data table according to an embodiment of the invention.

FIG. 5 shows a transaction volume by location report according to an embodiment of the invention.

FIG. 6 illustrates a flow diagram showing a method for sending a message to a server computer including control data associated with a discount, the control data being stored on a portable merchant device according to an embodiment of the invention.

FIG. 7 illustrates a flow diagram showing a method for receiving control data associated with a discount and modifying an authorization request message to apply the discount to a transaction according to an embodiment of the invention.

FIG. 8 illustrates a flow diagram showing a method for receiving control data associated with a discount, receiving authorization messages for a transaction, and transmitting a message to an issuer to apply the discount to the transaction according to an embodiment of the invention.

FIGS. 9A-9B show block diagrams of exemplary portable consumer devices according to embodiments of the invention.

FIG. 10 shows a block diagram of an exemplary access device according to an embodiment of the invention.

FIG. 11 shows a block diagram of a computer apparatus according to an embodiment of the invention.

### DETAILED DESCRIPTION

Prior to discussing embodiments of the invention, a further description of some terms may be helpful in understanding embodiments of the invention.

As used herein, a “portable merchant device” may be any suitable portable device that can store control data associated with a discount. For example, portable merchant devices can be hand-held and compact so that they can fit into a merchant's wallet and/or pocket (e.g., pocket-sized). Suitable portable merchant devices may include cards (e.g., similar in size and shape as a payment card), smart cards, cellular phones, wireless phones, smart phones, tablet computers, personal digital assistants (PDAs), pagers, portable computers, key fob devices, smart media, transponders, and the like.

As used herein, a “discount” may include a benefit provided to a consumer in the context of a payment transaction. For example, a discount can include a cost deduction for goods or services (e.g., a percentage deduction, a fixed amount deduction, etc.), free products or services (e.g., buy 1 get 1 free, buy product A get product B free, etc.), and the like. A discount may be provided in response to a consumer purchasing a single good or service or in response to a consumer purchasing multiple goods or services (e.g., an accumulated discount). The benefit of a discount may be applied to the cost of a single good or service, multiple goods or services, or the total cost of all goods or services associated with a single payment transaction.

As used herein, “control data” may include data stored on a portable merchant device that can facilitate the application of a discount to payment transactions conducted at a merchant associated with the portable merchant device. For example, control data may include an identifier of a specific discount (e.g., 10% off, 20% off, etc.). Control data may also include data that corresponds to a discount identifier that is stored external to the portable merchant device. For example, control data can be utilized to ascertain a particular discount based on data stored on a remote server computer. Such control data may include a merchant identifier (e.g., MVV, DBA, etc.), an access device identifier, a portable merchant device identifier (e.g., a unique sequence of alphanumeric characters associated with the device), and the like.

As used herein, a “transaction” may include an exchange or transfer of goods, services, and/or funds. For example, a transaction may be an exchange between a consumer and a merchant involving the consumer's purchase of goods and/or services from the merchant.

As user herein, a “merchant” may include an entity that can sell goods and/or services. Merchants can conduct transactions at a single location or at multiple locations. In some embodiments, a merchant can conduct transactions at different locations on a day-to-day basis (e.g., a mobile merchant). As used herein, an “acquirer” may be a business entity (e.g., a commercial bank) that has a business relationship with a particular mobile merchant or other entity. As used herein, an “issuer” may be a business entity (e.g., a bank) that maintains financial accounts for consumers such as individuals, businesses, and other entities, and that may issue portable consumer devices such as credit and debit cards to consumers. Some entities may perform both issuer and acquirer functions. Embodiments of the invention encompass such single entity issuer-acquirers.

As used herein, a “payment processing network” may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transaction, and other types of commercial transactions. VisaNet™, in particular, includes a VIP system (Visa Integrated Payments system) which processes authorization requests and a Base II system which performs clearing and settlement services.

As used herein, an “authorization request message” may include a data message, or sequence of data messages, that requests an issuer of a payment account to authorize a transaction. An authorization request message according to an embodiment of the invention may comply with ISO (International Organization for Standardization) 8583, which is a standard for systems that exchange electronic transactions made by cardholders using payment cards. An authorization request message according to other embodiments may comply with other suitable standards.

As used herein, an “authorization response message” may include a data message, or sequence of data messages, that responds to a merchant's and/or acquirer's request to authorize a transaction. An authorization response message according to an embodiment of the invention may comply with ISO 8583, which, as described above, is a standard for systems that exchange electronic transactions made by cardholders using payment cards. An authorization response message according to other embodiments may comply with other suitable standards.

As used herein, a “clearing message” may include a data message, or sequence of data messages, used to exchange financial details between an acquirer and an issuer to facilitate posting to a consumer's account and reconciliation of the consumer's settlement position, the posting and reconciliation being associated with one or more transactions.

As used herein, a “settlement message” may include a data message, or sequence of data messages, used to transfer funds between an acquirer and an issuer, the funds being associated with one or more transactions.

As used herein, a “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to one or more databases and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

As used herein, a “statement credit” may include a credit provided by an issuer of a portable consumer device, and applied to an account associated with the portable consumer device. Issuers may provide a consumer with periodic (e.g., monthly) statements reflecting charges, credits, and other information for the consumer's account. A statement credit provided by the issuer may be reflected in such a periodic statement. A statement credit may involve a deduction in an amount owed by the consumer to the issuer of the portable consumer device, or may involve an amount owed by the issuer to the consumer.

Embodiments of the invention are directed to systems, apparatuses, and methods for applying a discount to an electronic transaction based on control data stored in a portable merchant device. As described herein, a merchant access device can interact with a portable merchant device to retrieve stored control data associated with a discount. The access device can generate and electronically transmit a message including the control data to a server computer for application of the discount to transactions conducted by the merchant. In some embodiments, the server computer may be associated with a payment processing network configured to process electronic payment transactions and to provide clearing and settlement services. Upon receiving the control data, the payment processing network can apply the discount to subsequent transactions conducted by the merchant.

To illustrate, a merchant can enroll in a discount program and be issued one or more portable merchant devices, each device storing control data associated with a particular discount. For example, the merchant can be issued a card (e.g., similar in size and shape as a payment card) associated with a 15% discount, and a card associated with a 25% discount. The merchant may also be issued a card associated with no discount (i.e. a 0% discount) for the purpose of “turning off” the application of discounts. If, for example, the merchant desires to provide its customers with a 15% discount on transactions, the merchant can cause the card associated with the 15% discount to interact with an access device (e.g., a POS terminal) by swiping or scanning the card. The POS terminal may then generate a message including the control data associated with the 15% discount, and transmit the message to a server computer associated with a payment processing network.

Upon receipt, the payment processing network can apply the 15% discount to subsequent transactions conducted at the merchant. For example, if a consumer later conducts a transaction at the merchant with a portable consumer device (e.g., a payment card), the merchant's POS terminal may generate and transmit an authorization request message including the transaction amount to the payment processing network. When this message is received, the payment processing network can determine that the 15% discount is to be applied to the transaction. Before transmitting the message to the issuer for authorization of the transaction, the payment processing network can adjust the transaction amount included in the message to reflect the 15% discount. For example, if the authorization amount is $100, the payment processing network can modify the authorization request message to reflect an authorization amount of $85, and then forward the modified authorization request message to the issuer. Upon approval by the issuer, the consumer's account may be charged for the discounted transaction amount of $85.

As an alternative to modifying the transaction amount included in the authorization request message, the payment processing network may instead insert an indicator of the discount into the authorization request message. The payment processing network may then transmit the authorization request message including the indicator of the discount to the issuer for application of the discount to the transaction. For example, the payment processing network can forward the authorization request message reflecting the $100 authorization amount and an indicator of the 15% discount to the issuer. Upon completion of the transaction, the issuer can apply a statement credit (i.e. a $15 credit) to the account associated with the consumer's payment card. As another alternative, the payment processing network can transmit an indicator of the discount in a separate message to the issuer after authorization of the transaction has been completed. For example, the payment processing network can transmit the indicator of the discount to the issuer as part of a clearing or settlement message for the transaction that may be exchanged at the end of the day. Upon receipt, the issuer can apply a statement credit reflecting the 15% discount to the consumer's account.

The merchant may elect to adjust the discount to be applied to the merchant's transactions. For example, referring back to the above illustration, the merchant may want to increase the discount from 15% to 25%. By causing the card associated with the 25% discount to interact with the POS terminal, a message can be transmitted to the payment processing network that causes the 25% discount to be applied to subsequent transactions instead of the 15% discount. If the merchant decides to “turn off” all discounts, the merchant can swipe or scan the card associated with no discount (e.g., the 0% discount card) at the POS terminal which may transmit a message to the payment processing network that stops all discounts from being applied to the merchant's transactions.

I. Exemplary Systems

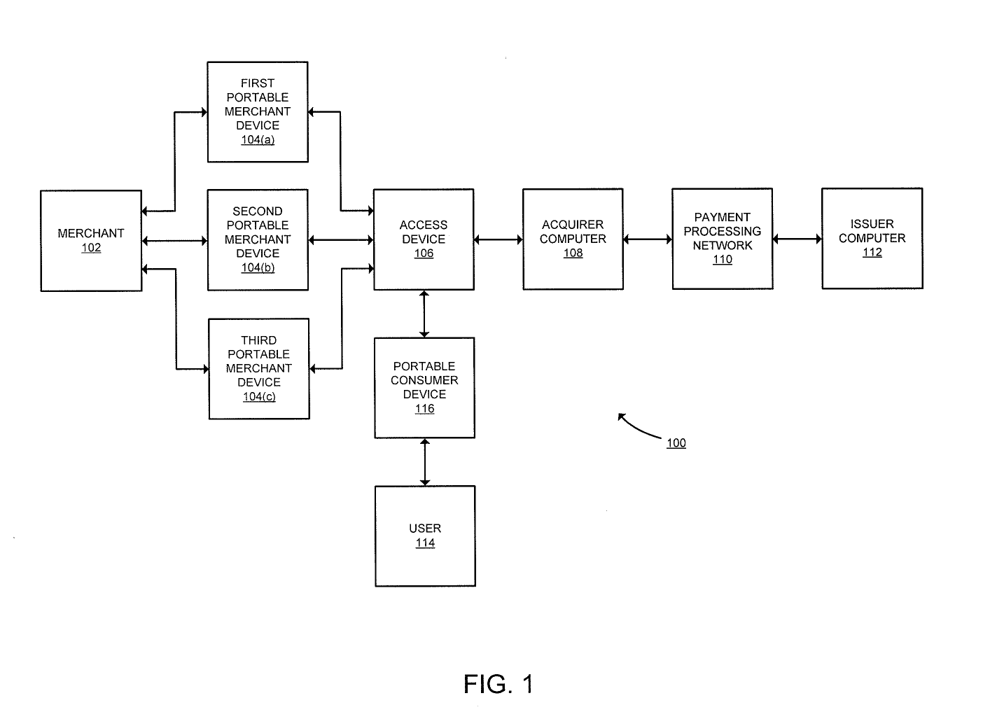

FIG. 1 shows a block diagram of a payment processing system 100 that may be used in an embodiment of the invention. System 100 may include a merchant 102, one or more portable merchant devices 104(a)-(c), an access device 106, an acquirer computer 108, a payment processing network 110, an issuer computer 112, a user 114, and a portable consumer device 116. In some embodiments, system 100 may also include one or more acquirer processor computers and issuer processor computers (now shown) corresponding to one or more acquirer processors and issuer processors, respectively.

Merchant 102 may be an entity that can sell goods and/or services, and that can conduct transactions at a single location or at multiple locations. In some embodiments, merchant 102 can conduct transactions at different locations on a day-to-day basis (e.g., as a mobile merchant).

Access device 106 may include a point of sale (POS) device, cellular phone (e.g., a smart phone), PDA, personal computer (PC), tablet PC, handheld specialized reader, set-top box, electronic cash register, ATM, virtual cash register, kiosk, security system, access system, and the like. If access device 106 is a POS terminal, any suitable POS terminal may be used including a card or phone reader. The card or phone reader may include any suitable contact or contactless mode of operation. For example, exemplary readers can include RF (radio frequency) antennas, magnetic stripe readers, and other readers to interact with the one or more portable merchant devices 104(a)-(c) and portable consumer device 116.

Acquirer computer 108 may be operated by an acquirer which may be a business entity (e.g., a commercial bank) that has a business relationship with merchant 102 or other entity. The acquirer may facilitate authorization, settling, and clearing of electronic payment transactions for merchant 102.

Payment processing network 110 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transaction, and other types of commercial transactions. VisaNet™, in particular, includes a VIP system (Visa Integrated Payments system) which processes authorization requests and a Base II system which performs clearing and settlement services.

Issuer computer 112 may be operated by an issuer which may be a business entity (e.g., a bank) that maintains financial accounts for consumers such as individuals, businesses, and other entities, and that may issue portable consumer devices such as credit and debit cards to consumers. For example, the issuer that operates issuer computer 112 may issue portable consumer device 116 to user 114. Some entities may perform both issuer and acquirer functions. Embodiments of the invention encompass such single entity issuer-acquirers.

User 114 may be any entity that has access to portable consumer device 116. For example, user 114 may be an individual, or an organization such as a business that is capable of purchasing goods or services. User 114 may also be a merchant, an employee of the merchant, or any other individual or entity that has access to portable consumer device 116. For example, in some embodiments, user 114 and merchant 102 may be the same entity.

Portable consumer device 116 may be in any suitable form. For example, portable consumer device 116 may be hand-held and compact so that it can fit into a user's wallet and/or pocket (e.g., pocket-sized). Portable consumer device 116 may include a processor, and memory, input devices, and output devices, operatively coupled to the processor. Specific examples of portable consumer devices may include cellular or wireless phones, personal digital assistants (PDAs), pagers, portable computers, smart cards, and the like. Portable consumer device 116 may also be a debit device (e.g., a debit card), credit device (e.g., a credit card), or stored value device (e.g., a pre-paid or stored value card).

The one or more portable merchant devices 104(a)-(c) may include any suitable portable devices that can store control data associated with a discount. For example, portable merchant devices 104(a)-(c) can be hand-held and compact so that they can fit into a merchant's wallet and/or pocket (e.g., pocket-sized). Suitable portable merchant devices can include cards (e.g., similar in size and shape as a payment card), smart cards, cellular phones, wireless phones, smart phones, tablet computers, personal digital assistants (PDAs), pagers, portable computers, key fob devices, smart media, transponders, and the like.

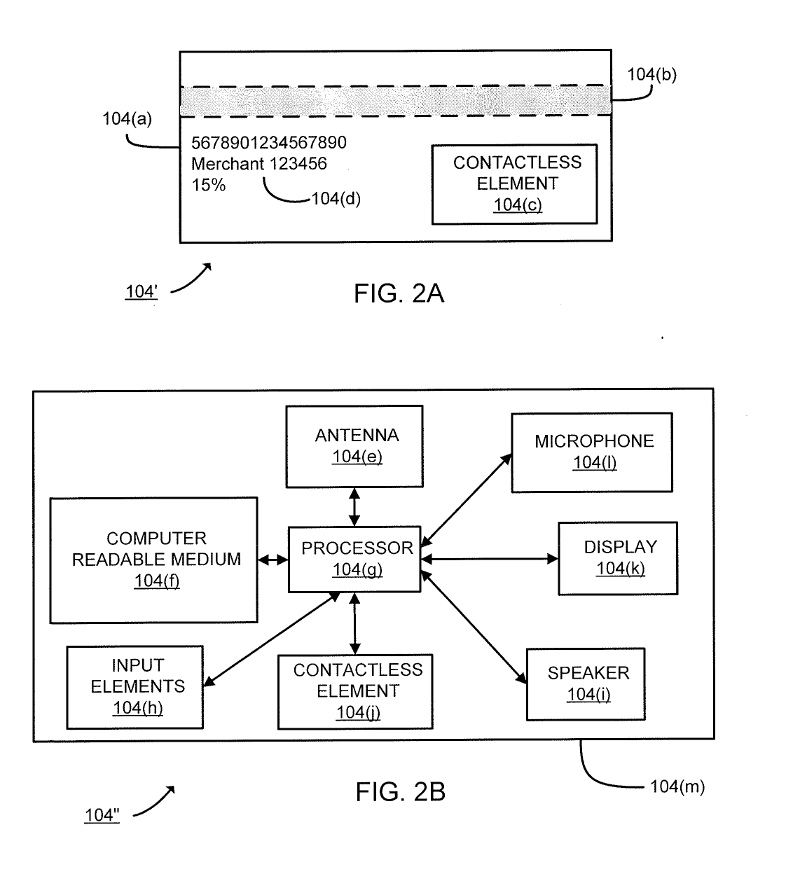

FIGS. 2A-2B show block diagrams of exemplary portable merchant devices 104′ and 104″ according to embodiments of the invention.

As shown in FIG. 2A, portable merchant device 104′ can be in the form of a card including a plastic substrate 104(a). A contactless element 104(c) for interfacing with access device 106 may be present on or embedded within plastic substrate 104(a). Merchant and discount information 104(d) such as a merchant device identifier, merchant identifier, discount identifier, and other information may be imprinted or embossed on the card. A magnetic stripe 104(b) may also be positioned on plastic substrate 104(a), and may store control data associated with a discount to be applied to transactions conducted at merchant 102. The control data may include an identifier of a particular discount (e.g., 10% off, 20% off, etc.). In some embodiments, the stored control data may correspond to a discount identifier that is stored external to the card (e.g., at payment processing network 110). Such control data may include a merchant identifier, an access device identifier, a portable merchant device identifier, and other information. The card may also include a microprocessor and/or memory chips (not shown) that store the control data. In some embodiments, the card may include a contactless element 104(c), which may be implemented in the form of a semiconductor chip (or other data storage element) with an associated wireless transfer (e.g., data transmission) element, such as an antenna. The contactless element 104(c) may be embedded within the card or located on plastic substrate 104(a). Control data may be exchanged with access device 106 by means of contactless element 104(c) using a near field communications (“NFC”) capability (or near field communications medium) in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the card and access device 106.

As shown in FIG. 2A, in some embodiments, the card may include both a magnetic stripe 104(b) and a contactless element 104(c). In other embodiments, either the magnetic stripe 104(b) or the contactless element 104(c) may be present in the card.

In some embodiments, the control data and other information stored in magnetic stripe 104(b), the processor, memory chip, and/or other storage element may be in the form of data tracks that are traditionally associated with payment cards such as credit cards, debit cards, and prepaid cards. Such tracks may include Track 1 (“International Air Transport Association”) and/or Track 2 (“American Banking Association”) which is currently most commonly used. This is the track that is typically read by access devices such as POS terminals, ATMs, and the like. The ABA (American Banking Association) designed the specifications of Track 2, and all world banks abide by it.

As shown in FIG. 2B, portable merchant device 104″ can be in the form of a phone that can be both a notification device that can be used to transmit control data associated with a discount to access device 106. The exemplary phone may comprise a computer readable medium 104(f) and a body 104(m). The computer readable medium 104(f) may be in the form of (or may be included in) a memory that stores control data associated with a discount. As with the card shown in FIG. 2A, the control data may include an identifier of a particular discount (e.g., 10% off, 20% off, etc.). In some embodiments, the stored control data may correspond to a discount identifier that is stored external to the card (e.g., at payment processing network 110). Such control data may include a merchant identifier, an access device identifier, a portable merchant device identifier, and other information. Any of this information may be transmitted by the phone to access device 106. In some embodiments, the control data and other information stored in the memory of the phone may also be in the form of data tracks that may include Track 1 and/or Track 2 as described above.

The phone may further include a contactless element 104(j), which may be implemented in the form of a semiconductor chip (or other data storage element) with an associated wireless transfer (e.g., data transmission) element, such as an antenna. The contactless element 104(j) may be associated with (e.g., embedded within) the phone and data or control instructions transmitted via a cellular network may be applied to the contactless element 104(j) by means of a contactless element interface (not shown). The contactless element interface may function to permit the exchange of data and/or control instructions between the mobile device circuitry (and hence the cellular network) and the optional contactless element 104(j).

The contactless element 104(j) may be capable of transferring and receiving data using a near field communications (“NFC”) capability (or near field communications medium) in accordance with a standardized protocol or data transfer mechanism (e.g., ISO 14443/NFC). As described above, near field communications capability is a short-range communications capability, such as RFID, Bluetooth™, infra-red, or other data transfer capability that can be used to exchange data between the phone and access device 106. Thus, the phone may be capable of communicating and transferring control data and/or other instructions via both a cellular network and near field communications capability.

The phone may also include a processor 104(g) (e.g., a microprocessor) for processing the functions of the phone and a display 104(k) to allow a consumer to see the phone numbers and other information and messages. The phone may further include input elements 104(h) to allow a user to input information into the device, a speaker 104(i) to allow the user to hear voice communication, music, etc., and a microphone 104(l) to allow the user to transmit her voice through the phone. The phone may also include an antenna 104(e) for wireless data transfer (e.g., data transmission).

Returning to FIG. 1, merchant 102 can cause one of the portable merchant devices 104(a)-(c) to interact with access device 106. This interaction may cause access device 106 to receive the control data stored in the selected portable merchant device. Access device 106 may then generate and transmit a message including the control data to acquirer computer 108, which may forward the control data to a server computer associated with payment processing network 110. The server computer may store a record of the received control data in a database (and/or in a volatile memory) so that the discount may be applied to subsequent transactions conducted by merchant 102.

In such a transaction, user 114 may purchase goods or services from merchant 102 using portable consumer device 116 which may be, for example, a credit, debit, or prepaid card. To initiate the transaction, portable consumer device 116 may interact with access device 116. For example, user 114 may take a credit card and swipe it though an appropriate slot in a POS terminal associated with merchant 102. Alternatively, the POS terminal may be a contactless reader, and portable consumer device 116 may be a contactless device such as a contactless card or phone. In this embodiment, user 114 may take the contactless card or a phone and pass it in front of the contactless reader to transmit financial information stored on the device.

An authorization request message may be generated by access device 106, the message including the transaction amount and other transaction data such as the account number, date and time, a merchant identifier, an access device identifier, account holder data, and other information. The authorization request message may be transmitted by access device 106 to acquirer computer 108. After receiving the authorization request message, acquirer computer 108 may then transmit the authorization request message to a server computer associated with payment processing network 110. The authorization request message may then be transmitted by payment processing network 110 to issuer computer 112.

After receiving the authorization request message, issuer computer 112 may perform a number of authorization, authentication, and fraud detection processes in order to make an authorization decision. Issuer computer 112 may then generate and send an authorization response message to payment processing network 110 indicating whether the transaction is approved. Payment processing network 110 may transmit the authorization response message to acquirer computer 108 which may then transmit the authorization response message back to access device 106.

Upon receipt of the authorization response message, access device 106 may provide the authorization response message to user 114 on a display or printed out on a receipt.

At the end of the day, a normal clearing and settlement process may be conducted by payment processing network 110 in cooperation with issuer computer 112 and acquirer computer 108. A clearing process can be a process of exchanging financial details between an acquirer and an issuer to facilitate posting to a consumer's account and reconciliation of the consumer's settlement position. A settlement process can be a process of transferring funds between an acquirer and issuer. In some embodiments, authorization and settlement can occur simultaneously.

As described herein, payment processing network 110 may apply a discount to the above-described transaction based on the control data received from access device 106. For example, in one embodiment, the server computer of payment processing network 110 may modify the transaction amount included in the authorization request message to reflect the discount before transmitting the authorization request message to issuer computer 112 for authorization of the transaction. If the transaction is authorized, the transaction amount charged by issuer computer 112 to the account of user 114 can be the discounted transaction amount. In other embodiments, the server computer of payment processing network 110 may apply the discount to the transaction without modifying the transaction amount. For example, an indicator of the discount can be inserted into the authorization request message. Upon receipt of the authorization request message including the indicator of the discount, and once the transaction has been approved, the issuer computer can provide user 116 with the benefit of the discount by applying a statement credit reflecting the discount to an account associated with portable consumer device 116. As another example, the server computer of payment processing network 110 may include the indicator of the discount in a separate message transmitted after the authorization process has been completed. For example, in some embodiments, the indicator may be inserted into a clearing or settlement message exchanged between issuer computer 112 and acquirer computer 108. After receiving the clearing or settlement message, issuer computer 112 may provide user 114 with the benefit of the discount by applying a statement credit to an account associated with portable consumer device 116. In some embodiments, a message including the indicator of the discount can be part of a batch file including indicators of discounts to be applied by issuer computer 112 to multiple transactions.

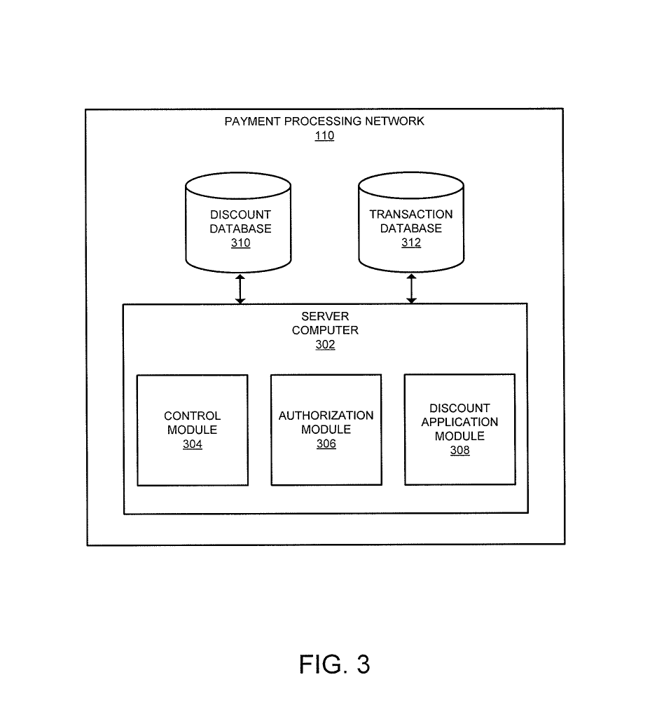

FIG. 3 shows a block diagram of payment processing network 110 according to an embodiment of the invention. For simplicity of discussion, only one of each component is shown for several of the components. It is to be understood, however, that embodiments of the invention may include more than one of each component. In addition, some embodiments of the invention may include fewer than all of the components shown in FIG. 3. The various modules and databases in FIG. 3 may each be located within payment processing network 110, outside payment processing network 110, and/or distributed at different locations. Further, the components in FIG. 3 may communicate via any suitable communication medium such as the Internet using any suitable communication protocol.

Payment processing network 110 may include a server computer 302 in communication with access device 106, acquirer computer 108, and issuer computer 112 shown in FIG. 1. Server computer 302 may also be in communication with one or more acquirer processor computers and issuer processor computers (now shown) operated by one or more acquirer processors and issuer processors, respectively.

As shown in FIG. 3, server computer 302 may include a control module 304, an authorization module 206, and a discount application module 308. The various modules may be embodied by computer code residing on a computer readable medium. Server computer 302 may be operatively coupled to one or more databases, including a discount database 310 and a transaction database 312.

Control module 304 may perform functions related to receiving control data transmitted by access device 106, updating and maintaining discount database 310 and transaction database 312, and exchanging authorization, clearing, and settlement messages with issuer computer 112, acquirer computer 108, access device 106, and the various modules of server computer 302. For example, upon receiving control data transmitted by access device 106 of merchant 102, control module 304 may update a record for merchant 102 stored in discount database 310 so that a discount associated with the control data may be applied to subsequent transactions conducted by merchant 102. When an authorization request message is received for a transaction conducted at merchant 102, control module 304 can determine whether to apply a discount to the transaction based on the record for merchant 102 stored in discount database 310. If no discount is to be applied (or if a discount is to be applied separate from the authorization process), control module 304 may route the authorization request message to authorization module 306 which may process and forward the request to issuer computer 112 for authorization of the transaction. If a discount is to be applied to the transaction, in some embodiments, control module 304 may route the authorization request message to discount application module 308 for modification of the message (i.e. by discount application module 308 modifying the transaction amount or inserting an indicator of the discount into the request message). Upon receipt of an authorization response message for a transaction from issuer computer 112, control module 304 may store a record of the transaction in transaction database 312, and may route the authorization response message to authorization module 306 for forwarding to access device 106 via acquirer computer 108.

In some embodiments, a discount can be applied to a transaction separate from the authorization process. For example, after authorization of a transaction is complete, control module 304 may receive a clearing or settlement message for the transaction from acquirer computer 108 or issuer computer 110. Control module 304 may then access the transaction record stored in transaction database 312 to determine whether a discount is to be applied to the transaction currently being cleared or settled. If a discount is to be applied, control module 304 may route the clearing or settlement message to discount application module 308 for application of the discount (i.e. by inserting an indicator of the discount prior to transmitting the message to issuer computer 112).

Authorization module 306 may perform a number of functions related to receiving, processing, and forwarding authorization, clearing, and settlement messages for electronic payment transactions. For example, if an authorization request message is received for a transaction for which no discount is to be applied, authorization module 306 can receive the request from control module 304, process the request, and transmit the request to issuer computer 112 for authorization of the transaction. If an authorization request message is modified by discount application module 308 to apply a discount, authorization module 306 can receive the modified request from discount application module 308, process the modified request, and transmit the modified request to issuer computer 112. Similarly, in the case of clearing or settlement messages received at server computer 302, authorization module 306 can cooperate with control module 304 and discount application module 308 to transmit modified (or unmodified) clearing or settlement messages to acquirer computer 108 and issuer computer 112 to facilitate clearing and settlement of the transaction.

Discount application module 308 may perform functions related to applying discounts to transactions. For example, discount application module 308 can receive an authorization request message for a transaction and control data associated with a discount from control module 304. Upon receipt, in one embodiment, discount application module 308 can modify a transaction amount included in the authorization request message to reflect the discount. In another embodiment, discount application module can insert an indicator of the discount into the authorization request message. After the request has been modified, discount application module 308 can transmit the modified message to authorization module 306 for forwarding to issuer computer 112. If a discount is to be applied during the clearing or settlement process, discount application module 308 may receive a clearing or settlement message for the transaction and control data associated with a discount from control module 304. Upon receipt, discount application module 308 can insert an indicator of the discount into the message. Upon modification of the clearing or settlement message, discount application module 308 may transmit the modified message to authorization module 306 for forwarding to issuer computer 112.

As described above, control module 304 may store and update stored records for merchants in discount database 310 in response to receiving control data associated with a discount. In embodiments of the invention, the records may be stored in discount database 310 in the form of discount data tables.

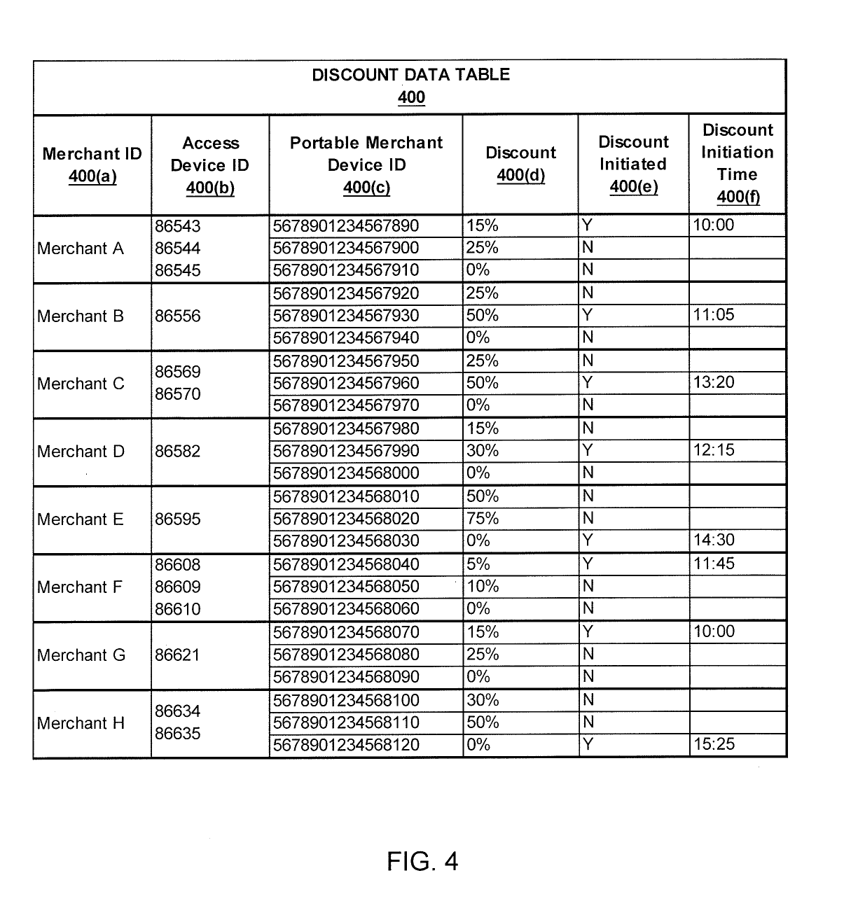

FIG. 4 shows a discount data table 400 as stored in discount database 310 according to an embodiment of the invention. As illustrated in FIG. 4, discount data table 400 may include various data fields including control data. As described herein, at least a portion of the control data stored in discount data table 400 can be received from an access device when a merchant initiates a discount, and at least a portion can also be received from the merchant as part of an enrollment process. For example, for each enrolled merchant, discount data table 400 may include a Merchant ID Field 400(a) including a merchant identifier (e.g., MW, DBA, etc.), an Access Device Field 400(b) including an identifier for one or more access devices, a Portable Merchant Device ID Field 400(c) including one or more portable merchant device identifiers (e.g., a unique alphanumeric code corresponding to the portable merchant device), and a Discount Field 400(d) including an indication of the discount (e.g., benefit) associated with each portable merchant device. As described above, the control data included in fields 400(a)-(d) may be provided by mobile merchants during an enrollment process. In some embodiments, during the enrollment process, merchants can provide control data via a web-based interface in communication with server computer 302. As shown in FIG. 4, discount data table 400 may also store control data for a merchant that is received by server computer 302 as the merchant begin to initiate discounts by causing their portable merchant devices to interact with an access device. For example, discount data table 400 can further include a Discount Initiated Field 400(e) including an indication whether the merchant has initiated a particular discount (e.g., based on control data received from an access device), and a Discount Initiation Time Field 400(f) including the time at which the merchant initiated the discount (e.g., the time at which the control data was received at server computer 302). Discount data table 400 may include additional fields with further control data such as contact information for the merchant (e.g., e-mail address, phone number, etc.), merchant preferences, and other information. Any suitable combination of the fields shown in discount data table 400 may be used, and more, less, or different fields may be included according to various embodiments of the invention.

Control module 304, as described above, may store a transaction record in transaction database 312 when a discount has been applied to a transaction, or when a transaction will later be applied to the transaction. The stored transaction records may server a number of different purposes. For example, the transaction records stored in transaction database 312 may allow for the generation of reports that provide merchants with details regarding their discounted transactions. Further, as described above, discounts may be applied after the authorization process is completed (e.g., during clearing or settlement) in embodiments of the invention. Thus, control module 304 may rely on the transaction records stored in transaction database 312 to determine whether a discount should be applied to a transaction that was previously authorized. In embodiments of the invention, the transaction records may be stored in transaction database 312 in the form of transaction data tables.

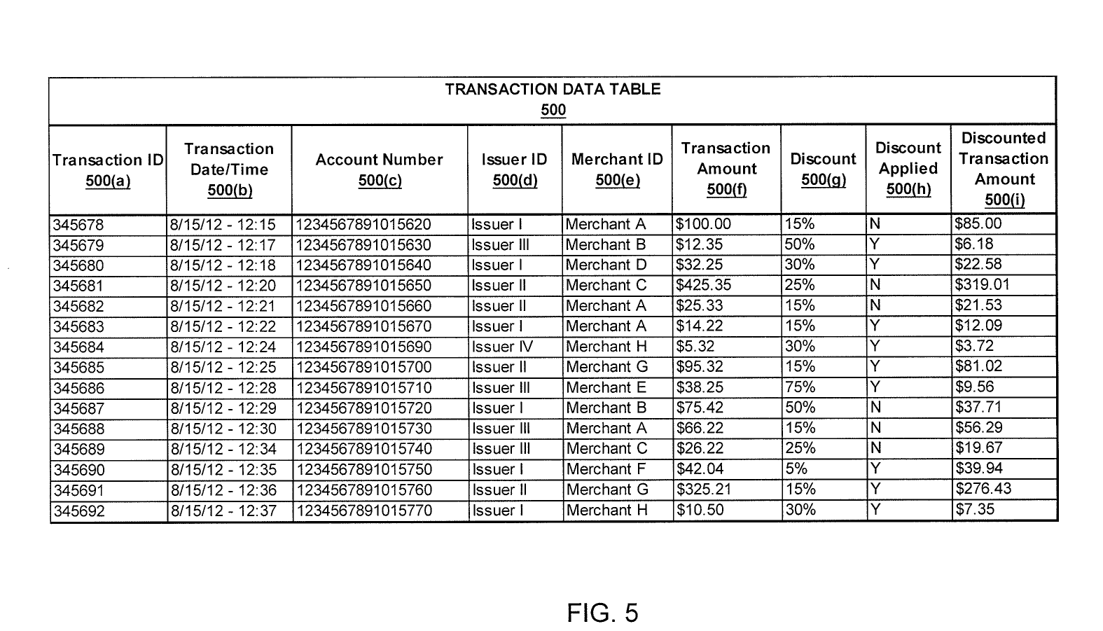

FIG. 5 shows a transaction data table 500 as stored in transaction database 312 according to an embodiment of the invention. As seen in FIG. 5, transaction data table 500 may include various data fields including transaction data for transactions for which a discount has or will be applied. For example, for individual transactions, transaction data table 500 may include a Transaction ID Field 500(a) including a transaction identifier (e.g., a unique alphanumeric code for the transaction), a Transaction Date/Time Field 500(b) including the date and time of the transaction, an Account Number Field 500(c) including the account used to pay for the transaction, an Issuer ID Field 500(d) including an issuer identifier (e.g., BIN, etc.), a Merchant ID Field 500(e) including a merchant identifier (e.g., MVV, DBA, etc.), a Transaction Amount Field 500(f) including the transaction amount before the discount is applied, a Discount Field 500(g) including the an indication of the discount (e.g., benefit) that has or will be applied to the transaction, a Discount Applied Field 500(h) including an indication whether the discount has been applied to the transaction, and a Discounted Transaction Amount Field 500(i) including the transaction amount after the discount is applied to the transaction. Transaction data table 500 may also include additional fields with further data such as one or more access device identifiers, transaction class (e.g., credit, debit, prepaid, etc.), acquirer identifier, acquirer processor identifier, issuer processor identifier, one or more error codes, cardholder or account holder information (e.g., name, date of birth, address, phone number, etc.), card verification value (CVV), expiration date, loyalty account information, and other information associated with the transaction. Any suitable combination of the fields shown in transaction data table 400 may be used, and more, less, or different fields may be included according to various embodiments of the invention.

II. Exemplary Methods

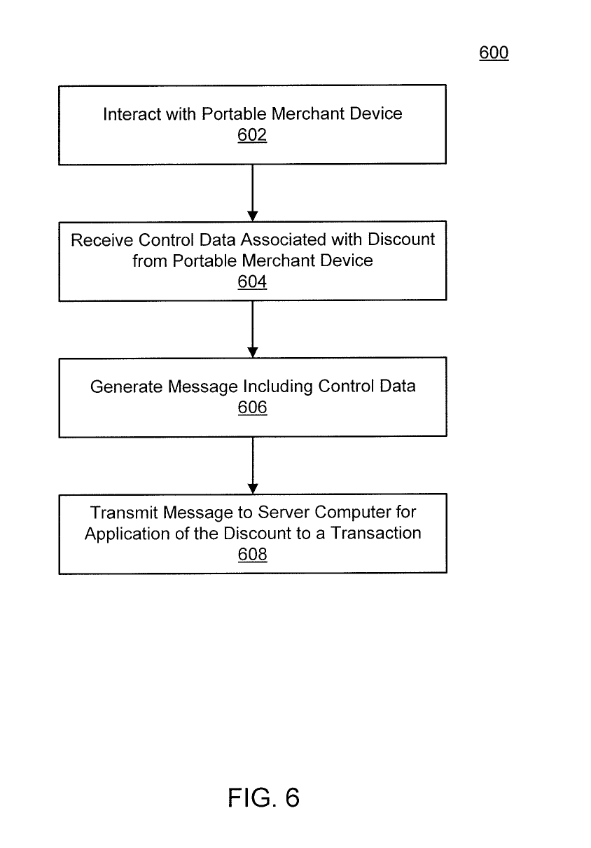

FIG. 6 illustrates a flow diagram showing a method 600 for sending a message to a server computer including control data associated with a discount, the control data being stored on a portable merchant device, according to an embodiment of the invention. The steps of method 600 can be performed, for example, by access device 106 shown in FIG. 1. In other embodiments of the invention, one or more steps of method 600 may be performed by any other suitable computing device.

As described above, a merchant can be issued one or more portable merchant devices, each storing control data associated with a particular discount (e.g., 10% off, 25% off, 50% off, etc.). The portable merchant devices can be in any suitable form. For example, the portable merchant devices can include cards with magnetic stripes, processors, and/or memories that store control data associated with a discount. The portable merchant devices can also be a single device such as a smartphone that stores control data associated with one or more discounts. The control data can include a specific identifier of the discount, or can include other data that corresponds to a discount identifier that is stored external to the portable merchant device. For example, if the portable merchant device does not store the discount identifier, it may store control data that can be utilized to ascertain a discount based on records stored at a remote database. Such control data may include a merchant identifier (e.g., MVV, DBA, etc.), an access device identifier, a portable merchant device identifier (e.g., a unique sequence of alphanumeric characters associated with the device), or any other suitable information that may be used to ascertain a discount associated with the portable merchant device.

In FIG. 6, at step 602, method 600 may begin by access device 106 interacting with a portable merchant device that stores control data associated with a discount. For example, the merchant can scan or swipe the portable merchant device at a reader of access device 106. As an illustration, the portable merchant device can be a card including a magnetic stripe storing control data associated with a 15% discount, and access device 106 can be a POS terminal including a magnetic stripe reader. In this illustration, at step 602, the merchant can swipe the card at the POS terminal.

At step 604, access device 106 can receive the control data associated with the discount from the portable merchant device. For example, if the portable merchant device is a smartphone that stores the control data in an internal memory, at step 604, the smartphone can wirelessly transmit the control data to access device 106. In some embodiments, access device 106 can receive the control data by reading a barcode, Quick Response (QR) code, or other code displayed on a display screen of the portable merchant device. In some embodiments, the merchant can utilize one or more buttons or a touch screen of the portable merchant device to input commands that cause the control data to be transmitted to access device 106. If the portable merchant device is a card, access device 106 may read the control data from a magnetic stripe of the card, or the card may store the control data in an internal processor and/or memory, and may wirelessly transmit the control data to access device 106 via a contactless element of the card. Referring back to the above illustration, at step 604, the control data may be read from the magnetic strip by the POS terminal, and may include a portable merchant device identifier that is associated with the 15% discount at a server computer associated with a payment processing network.

At step 606, access device 106 can generate a message including the control data. This message can be in any suitable format according to various embodiments of the invention. For example, in some embodiments, access device can generate a message in an ISO 8583 format. In other embodiments, an e-mail, SMS text message, or any other suitable message can be generated at step 606. At step 608, the message including the control data can be electronically transmitted to a server computer (e.g., server computer 302 shown in FIG. 3) for application of the discount to subsequent transactions conducted by the merchant. In some embodiments, the server computer may be associated with a payment processing network configured to process electronic payment transactions and to provide clearing and settlement services (e.g., payment processing network 110 shown in FIGS. 1-2. Referring back to the above illustration, at step 606, the POS terminal can generate and transmit a message including the portable merchant device identifier to the server computer associated with the payment processing network, the message being transmitted as an ISO 8583 message. For example, the portable merchant device identifier can be transmitted as a 16 digit number consistent with the account number format typically utilized by the ISO 8583 protocol.

In some embodiments of the invention, the control data can be stored on the same device that transmits the control data to the server computer. For example, the merchant can utilize a smartphone running an application that allows the merchant to select a discount to be applied to the merchant's transactions. The possible discounts may be predetermined, or the merchant may be able to manually and dynamically select a desired discount. Upon selection of the discount by the merchant via touch input, one or more keystrokes, or other input, the smartphone can transmit the control data associated with the discount to the server computer.

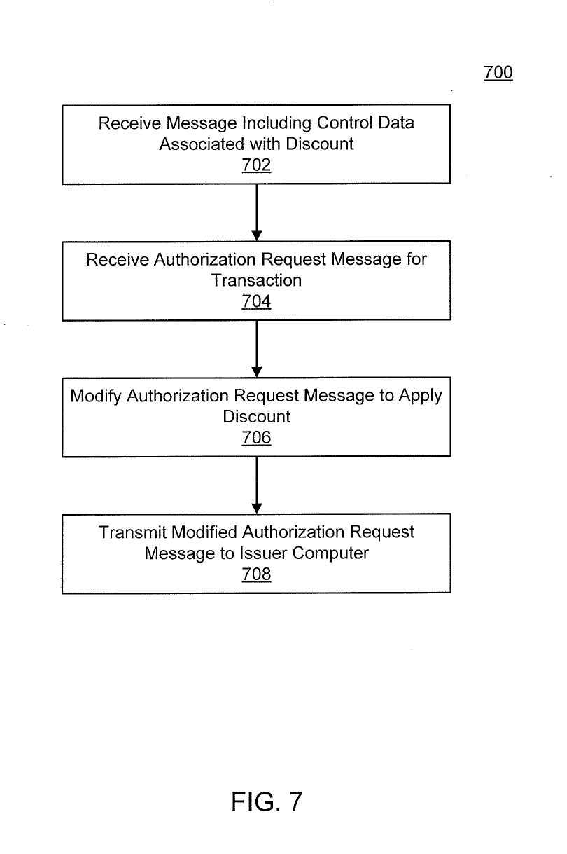

FIG. 7 illustrates a flow diagram showing a method 700 for receiving control data associated with a discount and modifying an authorization request message to apply the discount to a transaction, according to an embodiment of the invention. The steps of method 700 can be performed, for example, by server computer 302 shown in FIG. 3. In other embodiments of the invention, one or more steps of method 700 may be performed by any other suitable computing device.

At step 702, server computer 302 can receive the control data from the portable merchant device (e.g., corresponding to step 602 of method 600 shown in FIG. 6). Upon receipt by server computer 302, the control data associated with the discount may be stored. For example, server computer 302 may include volatile memory such as random access memory or RAM (sometimes referred to as system memory). The received transaction data may be stored in the RAM in some embodiments. Server computer 302 may also include non-volatile memory such as one or more databases, storage disks or devices, flash memory, or other non-volatile memory devices. For example, control module 304 (as shown in FIG. 3) can receive the control data from the portable merchant device, and update a record for the merchant stored in discount database 310 (as shown in FIG. 3) to reflect that the merchant has initiated a discount. Referring back to the above illustration, the merchant may be “Merchant A” listed in the Merchant ID Field 400(a) of discount data table 400 shown in FIG. 4. Upon receiving the portable merchant device identifier, control module 304 of server computer 302 may access discount data table 400, and determine that the portable merchant device identifier corresponds to a 15% discount based on Portable Merchant Device ID Field 400(c) and Discount Field 400(d). Control module 304 may then update the corresponding entry in Discount Initiated Field 400(e) to reflect that “Merchant A” has initiated a 15% discount for subsequent transactions.

At step 704, server computer 304 may receive an authorization request for a transaction conducted at the merchant by a user of a portable consumer device such as a credit or debit card. The authorization request message may be transmitted, for example, by access device 106 in response to interacting with the portable consumer device. In some embodiments, the authorization request message may include a merchant identifier, access device identifier, transaction amount, and/or other data associated with the transaction. Upon receipt, server computer 302 can determine whether a discount is to be applied to the transaction. For example, control module 304 may access the merchant records stored in discount database 310, and may match the merchant identifier, access device identifier, or other control data with the information stored in data fields 400(a)-(c) to determine if a discount included in Discount Field 400(d) is to be applied to the transaction. Referring back to the above illustration, at step 704, the received authorization request message may include a merchant identifier for Merchant A. By comparing this control data with the merchant records stored in discount database 110, control module 304 may determine that a 15% discount has been initiated my Merchant A, and that the discount is to be applied to the transaction.

Once the discount has been determined, at step 706, server computer 302 may modify the authorization request message to apply the discount to the transaction. In some embodiments, the authorization amount included in the authorization message may be reduced to reflect the discount. Referring back to the above illustration, the transaction amount may be $100, and based on the determined 15% discount, discount application module 308 of server computer 302 may change the transaction amount included in the authorization request message to $85. In other embodiments, the transaction amount can be left unmodified, and instead an indicator of the discount can be inserted into the authorization request message.

At step 708, server computer 302 may apply the discount to the transaction by electronically transmitting the modified authorization request message to a computer associated with an issuer of the portable consumer device. If the transmitted authorization request message includes the modified (i.e. discounted) transaction amount, and if the issuer authorizes the transaction, then the account associated with the portable consumer device may be charged for the discounted transaction amount. If the transaction amount included in the authorization request message was unmodified, and instead an indicator of the discount was inserted before transmission of the authorization request message to the issuer, the account associated with the portable consumer device may be charged for the original transaction amount. However, since the issuer can be aware of the discount due to the indicator being present in the authorization request message, the issuer can apply a statement credit reflecting the discount to the account associated with the portable consumer device. Referring back to the above illustration, at step 706, discount application module 308 may modify the authorization request message for the transaction by inserting an indicator of the 15% discount. At step 708, authorization module 306 may transmit the modified authorization request message to the issuer computer, which may then provide a $15 credit to the account associated with the portable consumer device.

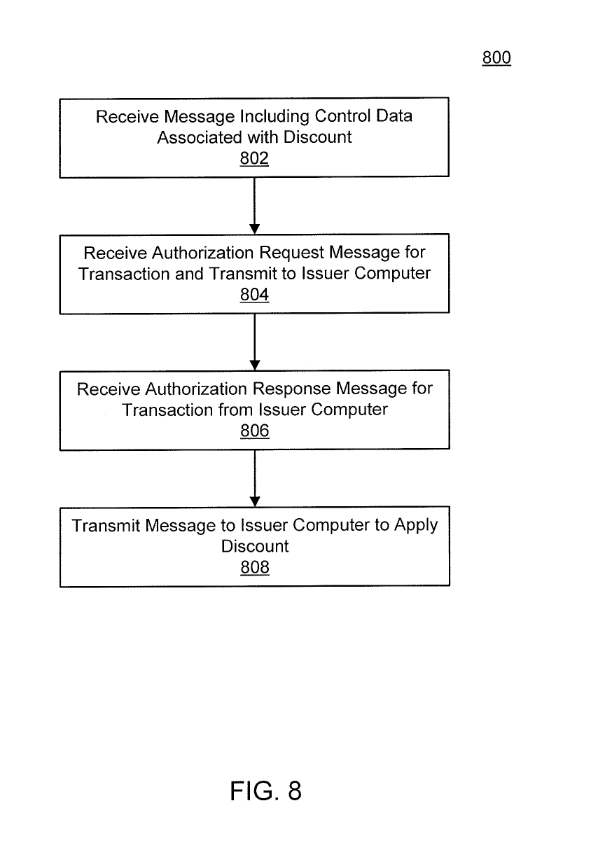

In some embodiments, the discount may be applied to the transaction separate from the authorization process (i.e. after the issuer has authorized the transaction). FIG. 8 illustrates a flow diagram showing a method 800 for receiving control data associated with a discount, receiving authorization messages for a transaction, and transmitting a message to an issuer to apply the discount to the transaction according to an embodiment of the invention. The steps of method 800 can be performed, for example, by server computer 302. In other embodiments of the invention, one or more steps of method 800 can be performed by any other suitable computing device.

At step 802, server computer 302 can receive the control data from the portable merchant device (e.g., corresponding to step 602 of method 600 shown in FIG. 6). Upon receipt by server computer 302, the control data associated with the discount may be stored. For example, server computer 302 may include volatile memory such as random access memory or RAM (sometimes referred to as system memory). The received transaction data may be stored in the RAM in some embodiments. Server computer 302 may also include non-volatile memory such as one or more databases, storage disks or devices, flash memory, or other non-volatile memory devices. For example, control module 304 (as shown in FIG. 3) can receive the control data from the portable merchant device, and update a record for the merchant stored in discount database 310 (as shown in FIG. 3) to reflect that the merchant has initiated a discount. Referring back to the above illustration, the merchant may be “Merchant A” listed in the Merchant ID Field 400(a) of discount data table 400 shown in FIG. 4. Upon receiving the portable merchant device identifier, control module 304 of server computer 302 may access discount data table 400, and determine that the portable merchant device identifier corresponds to a 15% discount based on Portable Merchant Device ID Field 400(c) and Discount Field 400(d). Control module 304 may then update the corresponding entry in Discount Initiated Field 400(e) to reflect that “Merchant A” has initiated a 15% discount for subsequent transactions.

At step 804, server computer 304 may receive an authorization request for a transaction conducted at the merchant by a user of a portable consumer device such as a credit or debit card. The authorization request message may include a merchant identifier, access device identifier, transaction amount, and/or other data associated with the particular transactions. Upon receipt, server computer 302 can determine whether a discount is to be applied to the transaction. For example, control module 304 may access the merchant records stored in discount database 310, and match the merchant identifier, access device identifier, or other information with the information stored in data fields 400(a)-(c) to determine if a discount included in Discount Field 400(d) is to be applied to the transaction. Referring back to the above illustration, at step 804, the received authorization request message may include a merchant identifier for Merchant A. Based on this information, control module 304 may determine that a 15% discount has been initiated based on the data included in Discount Field 400(d).

The authorization request message may be transmitted to a computer associated with an issuer of the portable consumer device used in the transaction, and at step 806, an authorization response messaging indicating whether the issuer has authorized the transaction may be received at server computer 302. If the authorization response message indicates that the transaction is approved, server computer 302 may store a record of the transaction. For example, control module 304 can receive the authorization response message and store a record of the transaction in transaction database 312. Referring back to the above illustration, at step 806, control module 304 may update transaction data table 500 shown in FIG. 5 to reflect that a transaction with an amount of $100 was conducted at “Merchant A,” and that the transaction is associated with a 15% discount, by populating fields 500(a)-(g). Control module 304 may also populate Discount Applied Field 500(h) to indicate that the 15% discount has yet to be applied to the transaction.

At step 808, server computer 302 may apply the discount by transmitting a message to the issuer computer. For example, in some embodiments, server computer 302 may receive a clearing or settlement message for the transaction from an acquirer or issuer computer. Upon receipt, server computer 304 may determine that a discount is to be applied to the transaction, and may modify the clearing or settlement message to reflect the discount before transmitting to the issuer computer. For example, after receiving the clearing or settlement message, control module 304 may access transaction data table 500 and determine (e.g., based on Discount Field 500(g) and Discount Applied Field 500(h)) that a discount is associated with the transaction but has yet to be applied. Control module 304 may then transmit the clearing or settlement message to discount application module 308, which may modify the message by inserting an indication of the discount. Authorization module 306 may then transmit the modified clearing or settlement message to the issuer computer. The issuer computer may then apply a statement credit to reflect the discount to the account associated with the portable consumer device. Referring back to the above illustration, at step 806, discount application module 308 may modify the settlement message for the transaction by inserting an indicator of the 15% discount. At step 808, authorization module 306 may transmit the modified settlement message to the issuer computer, which may then provide a $15 credit to the account associated with the portable consumer device.

In some embodiments of the invention, an indicator of a discount may be provided to the issuer computer as a standalone message separate from the authorization, clearing, and settlement processes. In various embodiments, the message including the indicator of the discount may comprise a batch filed including indicators for discounts to be applied to a plurality of transactions.

A merchant may be issued multiple portable merchant devices, each corresponding to a particular discount. In some embodiments, a single portable merchant device may be associated with multiple discounts. Thus, merchants may adjust the discount to be applied to their transactions by causing various portable merchant devices to interact with the merchant's access device in any suitable order. In embodiments of the invention, a portable merchant device may store control data associated with no discount (i.e. a 0% discount). A merchant may cause such a portable merchant device to interact with their access device, which may generate and transmit a message causing all discounts to be “turned off.” For example, upon receipt of such a message by server computer 302, control module 304 may update the merchant record stored in discount database 310 (e.g., Discount Field 400(d)) to indicate that no discount is to be applied to subsequent transaction conducted by the merchant.

Embodiments of the invention provide a number of advantages. By enabling merchants to provide discounts instantaneously and dynamically, merchants are provided with greater control over the redemption of such discounts. Merchants may adjust the value of the benefit and the period during which the discount is applied based upon customer demand. Since merchants are able to provide discounts at times when business is slow, and “turn off” discounts at times during which the merchant is already experiencing a high transaction volume, a merchant's sales revenue may be maximized. Further, by utilizing an existing payment processing network to facilitate the application of discounts, substantial changes to existing payment processing infrastructure may not be required according to various embodiments of the invention, and merchants may be provided with a convenient and efficient way to provide discounts that may draw in new customers and reward existing loyal customers.

III. Exemplary Portable Consumer Devices and Computer Apparatuses

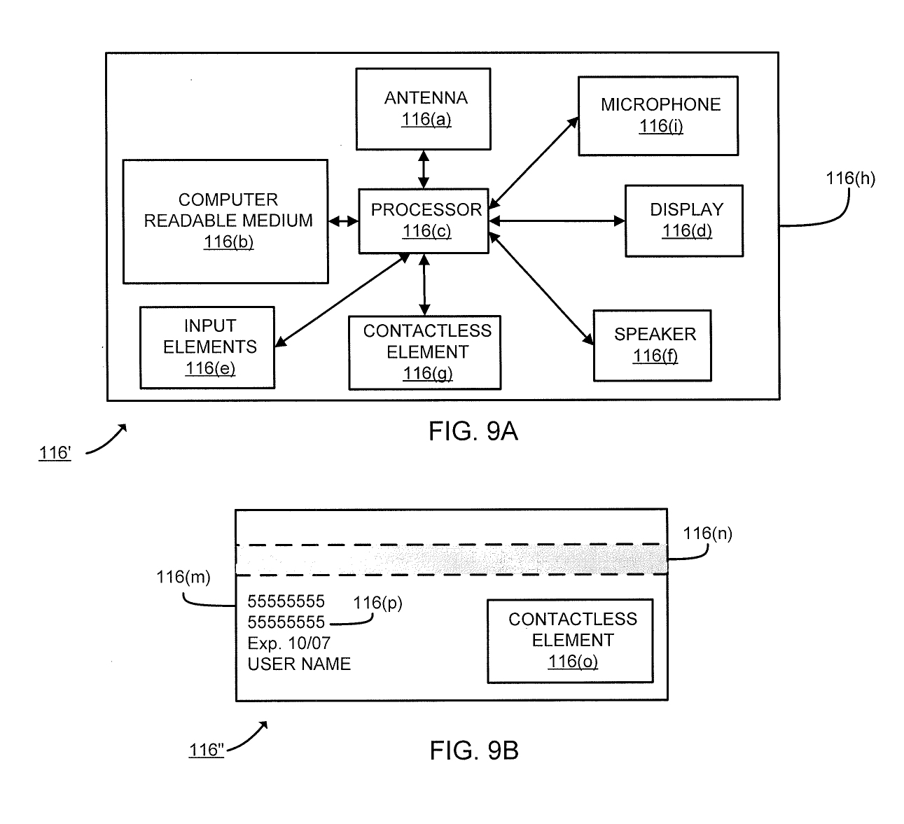

FIGS. 9A-9B show block diagrams of exemplary portable consumer devices according to embodiments of the invention.

FIG. 9A shows a block diagram of a phone 116′ that can be used in embodiments of the invention. The phone 116′ can be both a notification device that can receive alert messages, as well as a portable device that can be used to make payments. The exemplary phone 116′ may comprise a computer readable medium 116(b) and a body 116(h) as shown in FIG. 9A. The computer readable medium 116(b) may be in the form of (or may be included in) a memory that stores transaction data (e.g., issuer account numbers, loyalty provider account numbers, etc.) and may be in any suitable form including a magnetic stripe, a memory chip, etc. The memory may store information such as financial information, transit information (e.g., as in a subway or train pass), access information (e.g., as in access badges), etc. Financial information may include information such as bank account information, loyalty account information (e.g., a loyalty account number), an issuing bank identification number (BIN), credit or debit card number information, account balance information, an expiration date, consumer information such as the account holder's name, date of birth, etc. Any of this information may be transmitted by the phone 116′.

In some embodiments, information in the memory may also be in the form of data tracks that are traditionally associated with credit cards. Such tracks may include Track 1 and Track 2. Track 1 (“International Air Transport Association”) may store more information than Track 2, and may contain the cardholder's name as well as account number and other discretionary data. This track is sometimes used by the airlines when securing reservations with a credit card. Track 2 (“American Banking Association”) is currently most commonly used. This is the track that is read by ATMs and credit card checkers. The ABA (American Banking Association) designed the specifications of this track and all world banks abide by it. It contains the cardholder's account, encrypted PIN, plus other discretionary data.

The phone 116′ may further include a contactless element 116(g), which may be implemented in the form of a semiconductor chip (or other data storage element) with an associated wireless transfer (e.g., data transmission) element, such as an antenna. The contactless element 116(g) may be associated with (e.g., embedded within) the phone 116′ and data or control instructions transmitted via a cellular network may be applied to the contactless element 116(g) by means of a contactless element interface (not shown). The contactless element interface may function to permit the exchange of data and/or control instructions between the mobile device circuitry (and hence the cellular network) and the optional contactless element 116(g).

The contactless element 116(g) may be capable of transferring and receiving data using a near field communications (“NFC”) capability (or near field communications medium) in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the phone 116′ and an interrogation device. Thus, the phone 116′ may be capable of communicating and transferring data and/or control instructions via both a cellular network and near field communications capability.

The phone 116′ may also include a processor 116(c) (e.g., a microprocessor) for processing the functions of the phone 116′ and a display 116(d) to allow a consumer to see the phone numbers and other information and messages. The phone 116′ may further include input elements 116(e) to allow a user to input information into the device, a speaker 116(f) to allow the user to hear voice communication, music, etc., and a microphone 116(i) to allow the user to transmit her voice through the phone 116′. The phone 116′ may also include an antenna 116(a) for wireless data transfer (e.g., data transmission).

If the portable consumer device is in the form of a debit, credit, or smartcard, the portable consumer device may also optionally have features such as magnetic strips. Such devices can operate in either a contact or contactless mode.

An example of a portable consumer device 116″ in the form of a card is shown in FIG. 9B. FIG. 9B shows a plastic substrate 116(m). A contactless element 116(o) for interfacing with an access device may be present on or embedded within the plastic substrate 116(m). Consumer information 116(p) such as an account number, expiration date, and user name may be printed or embossed on the card. Also, a magnetic stripe 116(n) may also be on the plastic substrate 116(m). The portable consumer device 116″ may also comprise a microprocessor and/or memory chips with user data stored in them.

As shown in FIG. 9B, the portable consumer device 116″ may include both a magnetic stripe 116(n) and a contactless element 116(o). In other embodiments, both the magnetic stripe 116(n) and the contactless element 116(o) may be in the portable consumer device 116″. In other embodiments, either the magnetic stripe 116(n) or the contactless element 116(o) may be present in the portable consumer device 116″.

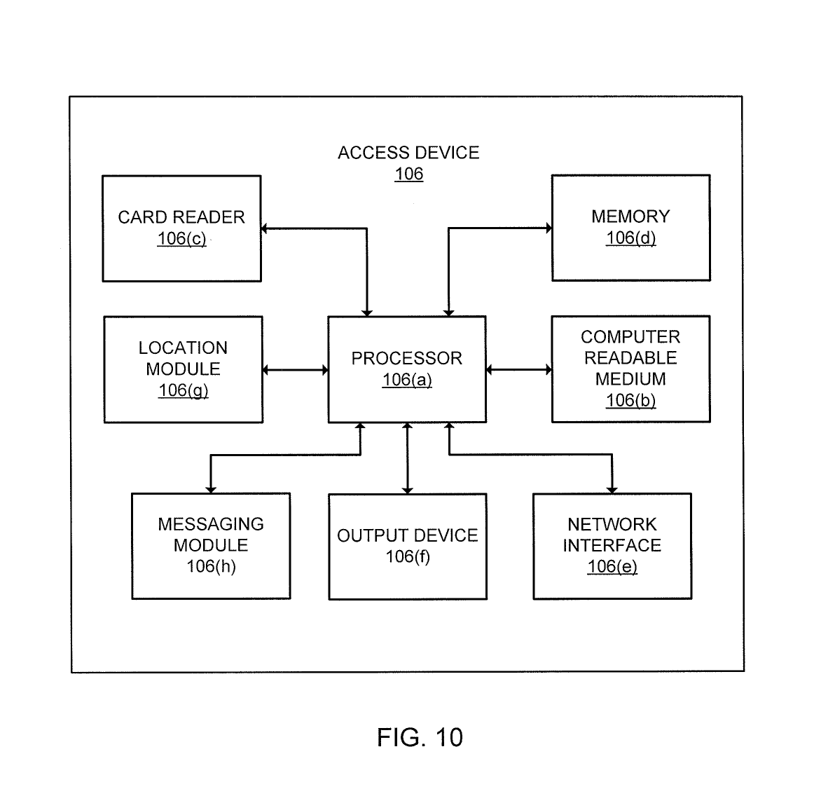

FIG. 10 shows a block diagram of an access device 106 according to an embodiment of the invention.

As shown in FIG. 10, the access device 106 may comprise a processor 106(a). It may also comprise a computer readable medium 106(b), a card reader 106(c), a memory 106(d), a network interface 106(e), an output device 106(f), a location module 106(g), and a messaging module 106(h), all operatively coupled to the processor 106(a). A housing may house one or more of these components. Suitable output devices 106(f) may include displays and audio output devices. Exemplary computer readable media 106(b) may include one or more memory chips, disk drives, etc. The card reader 106(c) of access device 106 may include one or more radio frequency (RF) antennas, magnetic stripe readers, etc., that can interact with portable merchants devices 104(a)-(c) and portable consumer device 116 shown in FIG. 1.

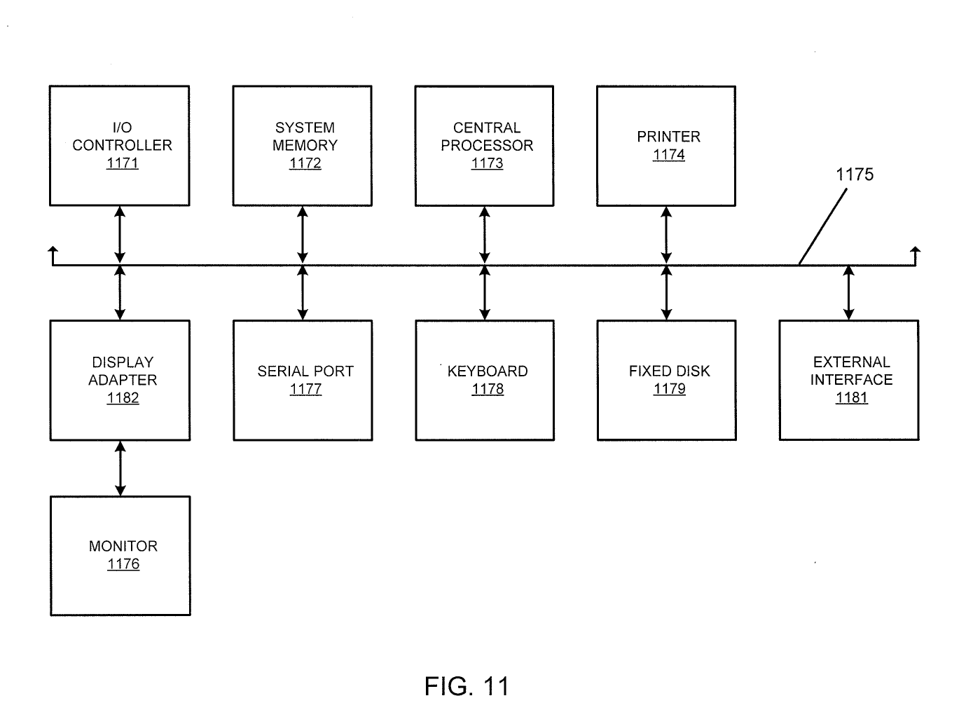

FIG. 11 shows a block diagram of a computer apparatus according to an embodiment of the invention.

The various participants and elements may operate one or more computer apparatuses (e.g., server computers) to facilitate the functions described herein, and any of the elements in the figures may use any suitable number of subsystems to facilitate the functions described herein. Examples of such subsystems or components are shown in FIG. 11. The subsystems shown in FIG. 11 are interconnected via a system bus 1175. Additional subsystems such as a printer 1174, keyboard 1178, fixed disk 1179 (or other memory comprising computer readable media), monitor 1176, which is coupled to display adapter 1182, and others are shown. Peripherals and input/output (I/O) devices, which couple to I/O controller 1171, can be connected to the computer system by any number of means known in the art, such as serial port 1177. For example, serial port 1177 or external interface 1181 can be used to connect the computer apparatus to a wide area network such as the Internet, a mouse input device, or a scanner. The interconnection via system bus 1175 may allow the central processor 1173 to communicate with each subsystem and to control the execution of instructions from the system memory 1172 or the fixed disk 1179, as well as the exchange of information between subsystems. The system memory 1172 and/or the fixed disk 1179 may embody a computer readable medium.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

Although control data associated with a discount is described in detail above, embodiments of the invention are directed to other types of control data. For example, the control data can be associated with a selection by a merchant of a particular payment processing network for processing a transaction, a particular interchange or switch fee structure associated with processing a transaction processing, a deferred settlement of a transaction (e.g., where the merchant agrees to defer settlement of the transaction in exchange for a reduced interchange or switch fee), a particular fraud detection process for a transaction, or other specific service. If the merchant's portable merchant device (and/or access device) is a smart phone, for example, the merchant may select such services and transmit the corresponding control data by entering touch input, one or more keystrokes, or other input on a user interface of the smartphone.

In some embodiments, a payment processing network may transmit a coupon or offer to the merchant's portable merchant device or access device via the Internet or any other suitable communication channel. The coupon or offer may be in the form of an e-mail, SMS, or any other suitable electronic message, and may relate to a payment processing service, interchange and/or switch fee structure, deferred settlement service, fraud detection service, or other specific service offered by the payment processing network or a related entity. In response to receiving an offer or coupon, the merchant may make a selection using a smartphone, for example, which may transmit the corresponding control data to the payment processing network. Such embodiments of the invention provide a number of advantages. For example, merchants come and go, and it can be difficult to determine whether a particular merchant has gone out of business at any given time. Thus, payment processing networks may be unable to effectively advertise various services to merchants. However, when a payment processing network receives authorization messages for transactions conducted by a particular merchant, the merchant's existence is confirmed, and information that can be used to identify and contact the merchant may be included in the authorization message. In embodiments of the invention, a coupon or offer can be transmitted to a merchant's access device or portable merchant device as soon as an authorization request message is received for the merchant. Consequently, payment processing networks and other entities may advertise their services more effectively to merchants, thereby increasing their return on investment.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited in this patent are hereby incorporated by reference for all purposes.

One or more features from any embodiment may be combined with one or more features of any other embodiment without departing from the scope of the disclosure.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method performed by an access device, the method comprising:
interacting with a portable merchant device associated with a merchant, the portable merchant device storing control data;
generating, by a processor in the access device, a message including the control data; and
electronically transmitting the message to a server computer, the control data causing the server computer to reconfigure for a transaction conducted by the merchant.

2. The method of claim 1, wherein the server computer is associated with a payment processing network configured to process electronic payment transactions and to provide clearing and settlement services.

3. The method of claim 2 further comprising:
interacting with a portable consumer device to initiate the transaction;
generating, by the processor in the access device, an authorization request message for the transaction; and
electronically transmitting the authorization request message to the server computer.

4. The method of claim 3, wherein the reconfiguration relates to applying a discount to the transaction, and wherein applying the discount to the transaction comprises:
modifying a transaction amount included in the authorization request message to reflect the discount; and
electronically transmitting the authorization request message including the modified transaction amount to an issuer computer associated with an issuer of the portable consumer device.

5. The method of claim 3, wherein the reconfiguration relates to applying a discount to the transaction, and wherein applying the discount to the transaction comprises:
generating a message including an indicator of the discount; and
electronically transmitting the message including the indicator to an issuer computer associated with an issuer of the portable consumer device, the indicator causing the issuer computer to provide a statement credit reflecting the discount to a user associated with the portable consumer device.

6. The method of claim 5, wherein generating the message including the indicator of the discount comprises inserting the indicator into the authorization request message, and wherein electronically transmitting the message including the indicator comprises electronically transmitting the authorization request message including the indicator.

7. The method of claim 5, wherein the message including the indicator of the discount comprises a batch file associated with a plurality of transactions.

8. The method of claim 1, wherein the portable merchant device is a first portable merchant device, the control data is a first control data, the transaction is a first transaction, and the message is a first message, and wherein the method further comprises:
interacting with a second portable merchant device associated with the merchant, the second portable merchant device storing a second control data;
generating, by a processor in the access device, a second message including the second control data; and
electronically transmitting the second message to the server computer, the second control data causing the server computer to reconfigure for a second transaction conducted by the merchant.

9. A method performed by a server computer, the method comprising:
receiving a message including control data, the message being generated by an access device that interacts with a portable merchant device associated with the merchant, the portable merchant device storing the control data; and
reconfiguring for a transaction conducted by the merchant.

10. The method of claim 9, wherein the server computer is associated with a payment processing network configured to process electronic payment transactions and to provide clearing and settlement services.

11. The method of claim 10 further comprising receiving an authorization request message for the transaction, the message being generated by the access device, the access device interacting with a portable consumer device to initiate the transaction.

12. The method of claim 11, wherein the reconfiguration relates to applying a discount to the transaction, and wherein applying the discount to the transaction comprises:
modifying a transaction amount included in the authorization request message to reflect the discount; and
transmitting the authorization request message including the modified transaction amount to an issuer computer associated with an issuer of the portable consumer device.

13. The method of claim 11, wherein the reconfiguration relates to applying a discount to the transaction, and wherein applying the discount to the transaction comprises:
generating a message including an indicator of the discount; and
transmitting the message including the indicator to an issuer computer associated with an issuer of the portable consumer device, the indicator causing the issuer computer to provide a statement credit reflecting the discount to a user associated with the portable consumer device.

14. The method of claim 13, wherein generating the message including the indicator of the discount comprises inserting the indicator into the authorization request message, and wherein transmitting the message including the indicator comprises transmitting the authorization request message including the indicator.

15. A computing device comprising:
a processor; and
a computer readable medium coupled to the processor, wherein the computer readable medium comprises code executable by the processor for implementing a method comprising:
interacting with a portable merchant device associated with a merchant, the portable merchant device storing control data;
generating a message including the control data; and
electronically transmitting the message to a server computer, the control data causing the server computer to reconfigure for a transaction conducted by the merchant.

16. The computing device of claim 15, wherein the server computer is associated with a payment processing network configured to process electronic payment transactions and to provide clearing and settlement services.

17. The computing device of claim 16, wherein the method further comprises:
interacting with a portable consumer device to initiate the transaction;
generating an authorization request message for the transaction; and
electronically transmitting the authorization request message to the server computer.

18. The computing device of claim 17, wherein the reconfiguration relates to applying a discount to the transaction, and wherein applying the discount to the transaction comprises:
modifying a transaction amount included in the authorization request message to reflect the discount; and
electronically transmitting the authorization request message including the modified transaction amount to an issuer computer associated with an issuer of the portable consumer device.

19. The computing device of claim 17, wherein the reconfiguration relates to applying a discount to the transaction, and wherein applying the discount to the transaction comprises:
generating a message including an indicator of the discount; and
electronically transmitting the message including the indicator to an issuer computer associated with an issuer of the portable consumer device, the indicator causing the issuer computer to provide a statement credit reflecting the discount to a user associated with the portable consumer device.

20. The computing device of claim 19, wherein generating the message including the indicator of the discount comprises inserting the indicator into the authorization request message, and wherein electronically transmitting the message including the indicator comprises electronically transmitting the authorization request message including the indicator.
